(19) United States
(12) Patent Application Publication
(10) Pub. No.: US 2003/0093290 A1
(43) Pub. Date: May 15, 2003

(54) Method and system for providing management of power supply units

(76) Inventors: Bernard Melsom, Tyreso (SE); Mats Loman, Ronninge (SE); Joel Binnquist, Huddinge (SE); Remco Tissink, Varby (SE)

Correspondence Address: HARNESS, DICKEY & PIERCE, P.L.C., P.O. BOX 828, BLOOMFIELD HILLS, MI, 48303, US

(21) Appl. No.: 10/221,892

(22) PCT Filed: Mar. 19, 2001
(86) PCT No.: PCT/SE01/00568

(30) Foreign Application Priority Data
Mar. 17, 2000 (SE) 0000887-0

(51) Int. Cl. G06F 17/60

(52) U.S. Cl. 705/1

(57) ABSTRACT

The invention refers to a method for management of power supply units comprising at least one central supervising unit (CSU) (307), and at least one combination (301) of power supply units (PSU)(309), said units connected to said central supervising unit (CSU)(307), said at least one combination (301) to be managed by said at least one central supervising unit, the method comprising following steps: (a) parsing information contained in a CIL File (201), said file describing, through the use of CIL statements, physical units connected to the combination using a first parser (202); (b) said first parser creating from said information an Information Model (208) comprising Static Units (207) and Dynamic Units (212), a Type Information (206) comprising: Alarm Types (203), Unit Types (204), and Device Types (205); (c) said first parser further creating a second parser, I/O Equipment Parser (211) for parsing a Device List (815) provided by an I/O Interface (813), said Interface being the connection to the at least one combination (301) to be managed by said at least one central supervising Unit (CSU); (d) said first parser also creating from further CIL Statements contained in the CIL File (201), an Application (210) for management of the units contained in the Combination (301); (e) said application using the Information Model (208) and the Type Information (206) in managing the Combination (301). The invention further relates to a power supply system and a computer program performing the above steps.

### TECHNICAL FIELD

The invention relates to a method and a system for providing management for power supply units in a data- or telecommunication system it also relates to a method and system for upgrading functionality in this type of systems.

### BACKGROUND OF THE INVENTION AND PRIOR ART

In telecommunication applications covering a large area, such as e.g. a region or more there is a need for managing the status of the different power supply units placed in that region. The power supply units may e.g. belong to equipment like routers, telephone exchanges, transmitters and receivers etc. It would be impracticable to manage all these power supply units by inspection and also there is a need for alarm functions connected to possible events in these units such that a possible failure in a unit will be brought to attention immediately.

In the management of power supply units for e.g. telecommunication networks it is common to let a Central Supervising Unit CSU collect data from each separate power supply unit, i.e. the individual components, battery/-ies, rectifier/-s etc. comprised in the power supply unit. The CSU then communicates with an Agent. In a region there may be more than one agent. The agents may in turn communicate with a Manager, which is a program running on e.g. a workstation. In order to update the Manager information is sent through the network via an Agent from the CSU to the Manager.

In this type of system there is a problem when new hardware which generates data to be forwarded to the Manager is added. According to prior art the solution to this problem is to code each new added hardware directly in a software program used by the CSU for managing the power supply units. However such a solution is awkward and not user-friendly. One of the reasons for this is that such a file programmed in a common language as e.g. C++, would have a size in compiled form of around 1 Mbyte.

Also when updating the equipment the CSU software must be compiled, distributed and stored as a replacement after each change.

### SUMMARY OF THE INVENTION

Definitions used in the text below:

EEM 2001 Platform, according to the invention, is a software and stands for Emerson Energy Management Platform. The software contains several parts, e.g. Equipment Handling, alarm Handling and I/O Equipment Handling. In short the EEM 2001 Platform provides a framework for crating the Application. The EEM 2001 Platform is designed to be event driven.

Configuration Information Parser: The Configuration Parser parses/compiles the configuration Information and generates the I/O Equipment Parser.

Equipment System is a number of physical units which are connected under one CSU

It is an object of the present invention to provide a method, a system and a computer program, which overcomes the problem outlined above.

This and further objects, described in the text below, are attained according to the invention by providing a tool where the application developer can define an Information Model and an Application that operates on the data contained in the Information Model in the software used for managing the system. The system is provided with means for providing additions (physically and logically) of Equipment and new functionality.

According to the invention the base software, such as the EEM platform, holds definitions of functional components, which may be combined into Energy Management applications. This is accomplished by using a compact high level representation for devices, conditions, actions etc., below termed CIL, short for EMM “Configuration Information Language”. This representation describes in a text file the configuration and the application in e.g. a power supply supervisor. Upgrades are made by changes in the text file to define the new configuration.

CIL also provides instructions for defining and implementing the behavior of an application. The CIL Application is designed to be event driven. A CIL Application is divided into one or more parts (sub applications, or logical function blocks) called Context. Each Context is triggered by an Update Group.

An Update Group is a collection of I/O Devices scheduled for an update (data exchange with an I/O Interface Subsystem) do be done within a specified time interval.

This provides for less space being needed (approx. in the order of 10-20 kB) for downloading upgrades of the software, related to the functionality of the system. This clearly also provides for a higher reliability as to the success of the downloaded new configuration.

The Information Model is structured as a tree where each node is a logical sub-grouping of nodes. The Information Model is populated in two ways, either before any I/O-device patterns are detected or performed during a I/O-device pattern matching procedure, i.e. combinations of I/O Devices comprised in one Equipment Unit. This provides the hierarchical information on each power supply unit. A node representing the information in the agent or the whole system as such, or information as regards the physical units represented in the model.

The Information Model represents a logic structure, that according to the invention can be updated so that it at every point of time corresponds to the equipment currently used in the system.

The invention thus refers to a method for management of power supply units comprising at least one central supervising unit (CSU), and at least one combination of power supply units (PSU), said units connected to said central supervising unit (CSU), said at least one combination to be managed by said at least one central supervising unit, the method comprising following steps:

(a) parsing information contained in a CIL File, said file describing, through the use of CIL statements, physical units connected to the combination using a first parser;

(b) said first parser creating from said information an Information Model comprising Static Units and Dynamic Units, a Type Information comprising Alarm Types, Unit Types, and Device Types;

(c) said first parser further creating a second parser, I/O Equipment Parser for parsing a Device List provided by an I/O Interface, said Interface being the connection to the at least one combination to be managed by said at least one central supervising Unit (CSU);

(d) said first parser also creating from further CIL Statements contained in the CIL File, an Application for management of the units contained in the Combination.

(e) said application using the Information Model and the Type Information in managing the Combination.

The invention also refers to a power supply system comprising power supply units, said system comprising at least one central supervising unit (CSU), and at least one combination of power supply units (PSU), said units connected to said central supervising unit (CSU), said at least one combination to be managed by said at least one central supervising unit characterized by means for

(a) parsing information contained in a CIL File, said file describing, through the use of CIL statements, physical units connected to the combination;

(b) creating from said information an Information Model comprising Static Units, and Dynamic Units, a Type Information comprising Alarm Types, Unit Types, and Device Types;

(c) for creating a second parser, I/O Equipment Parser for parsing a Device List provided by an I/O Interface, said Interface being the connection to the at least one combination to be managed by said at least one central supervising Unit (CSU);

(d) for creating from further CIL Statements contained in the CIL File, an Application for management of the units contained in the Combination.

(e) for using the Information Model and the Type Information in order to manage the Combination.

The invention further relates to a computer program, which when run on a computer, in a method for management of power supply units comprising at least one central supervising unit (CSU), and at least one combination of power supply units (PSU), said units connected to said central supervising unit (CSU), said at least one combination to be managed by said at least one central supervising unit, performs the following steps:

(a) parsing information contained in a CIL File, said file describing, through the use of CIL statements, physical units connected to the combination using a first parser;

(b) said first parser creating from said information an Information Model comprising Static Units and Dynamic Units, a Type Information comprising Alarm Types, Unit Types, and Device Types;

(c) said first parser further creating a second parser, I/O Equipment Parser for parsing a Device List provided by an I/O Interface, said Interface being the connection to the at least one combination to be managed by said at least one central supervising Unit (CSU);

(d) said first parser also creating from further CIL Statements contained in the CIL File, an Application for management of the units contained in the Combination.

(e) said Application using the Information Model and the Type Information in managing the Combination.

### BRIEF DESCRIPTION OF THE DRAWINGS

The invention will now be described in more detail by way of non-limiting examples and with reference to the accompanying drawings, in which:

FIG. 1 illustrates the structure of the EMM-core comprising the method specific means according to the invention.

FIG. 2 illustrates the relation between Type Information, Information Model, CIL file, I/O Interface, and Application.

FIG. 3 illustrates the general structure of the equipment in a power supply system.

FIG. 4 illustrates the relation between the method according to the invention and the EEM software platform.

FIG. 5a circuit diagram for a System Voltage Monitor.

FIG. 5b CIL Execution Model for a System Voltage Monitor

FIG. 6a illustrates a software description of a combination of input/output (I/O) Devices, i.e. a configuration file.

FIG. 6b illustrates a software description relating to the behavior of a fan used for cooling.

FIG. 7 illustrates steps carried out when adding a piece of new equipment in the structure as shown in FIG. 3.

FIG. 8 illustrates the interaction of the I/O Equipment Parser with the I/O Interface

FIG. 9 illustrates the parse tree created by the I/O Equipment Parser using the software shown in FIG. 6a.

FIG. 10 illustrates the Application and its interaction with Parameters, I/O Equipment Handling and the Information Model.

FIG. 11 illustrates in a flow sheet the chronological order of events in the Application

### DESCRIPTION OF PREFERRED EMBODIMENTS

In the text below the wording I/O Devices refers to Devices connected to the system via an I/O Interface and which exchanges data with the Information Model.

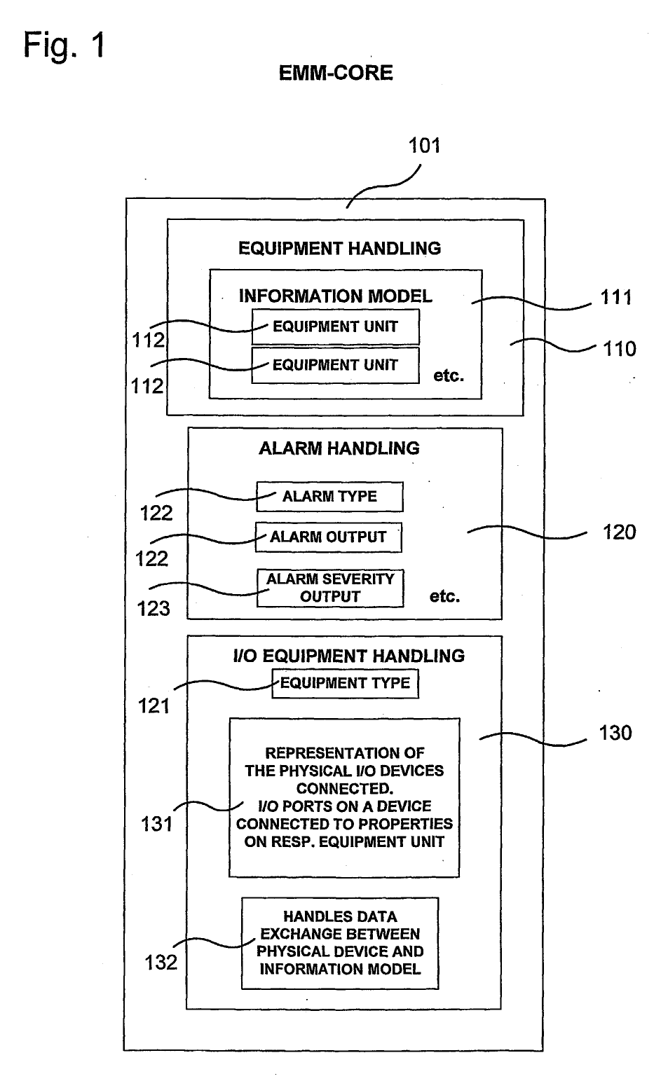

In FIG. 1 the EMM-core 101 is illustrated. The core comprises, i.e. the following three units, Equipment Handling 110, Alarm Handling 120, and I/O Equipment Handling 130.

The Equipment Handling 110 comprises the Information Model 111, which is the logical representation of the I/O Devices that are detected by an I/O Equipment Parser. The I/O Equipment Parser is the output of a Configuration Information Parser (Configuration Information Parser parses/compiles the Configuration Information. The I/O Equipment Parser creates Dynamic Equipment Units from a set of I/O Devices. All Equipment Units are Dynamic Equipment Units, and are logical representations of I/O Devices.

The Information Model 111 contains one or more Equipment Units 112, which are created from I/O Devices. Each Equipment Unit is defined by an Equipment Type. An Equipment Type may define a set of Properties belonging to the Equipment Type. A Property represents a value (real or Boolean) or an Alarm Indicator. A property can be mapped to an I/O Port.

The Alarm Handling 120 contains the representation of alarm information. An Equipment Type 121 can be associated with a set of Alarm Types 122,123. An Equipment Unit (see The Information Model) is an instance of an Equipment Type. Each associated Alarm Type will be instanced as an Alarm Indicator owned by the Equipment Unit.

The Alarm Handling also comprises Alarm Output 122 and Alarm Severity Output 123, both are associated with an I/O Port.

The I/O Equipment Handling 130 comprises a Representation of the Physical I/O Devices 131 connected to the system. The I/O Ports of devices mapped are connected to properties on resp. Equipment Unit.

The I/O Equipment Handling 130 also handles Data Exchange 132 between physical devices and the Information Model 111. A Data Exchange Scheduler schedules the data exchange for all the I/O Interfaces, i.e. the shoveling of values between the I/O Devices and the physical I/O Devices. The Data Exchange scheduler comprises one or more Update Groups, each group defining it Update Interval. The Update Group comprises I/O Devices. When an Update Group is invoked by the Scheduler it invokes the update procedure for each contained I/O Device.

The three Handling Units illustrated interact with each other to perform the method according to the invention.

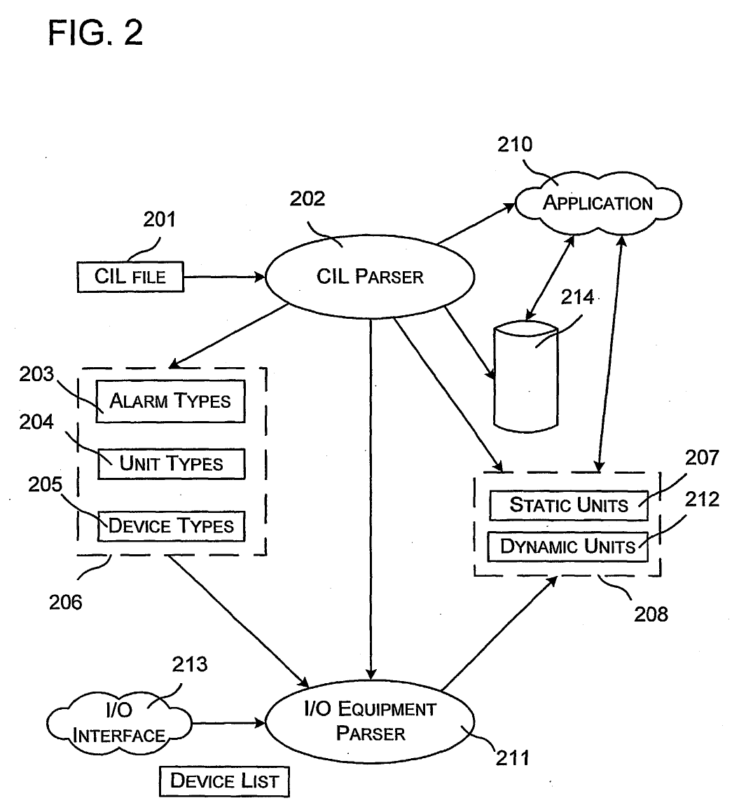

In FIG. 2 is shown the relation between Type Information 206, Information Model 208, CIL file 201, I/O Interface 213, and the Application 210. It also describes the interaction between the CIL Parser 202 and The I/O Equipment Parser 211. Further the method of defining an Information Model and an Application that operates on data contained in the Information Model will be explained.

In the figure is shown the CIL-file 201, which is a text file comprising data as to possible physical units, which may be or may become part of the equipment to be managed by the application. The text file may be edited and new logical units and their corresponding data may be added to the CIL file in order to update the physical combination of units. The CIL file is according to the invention parsed by a CIL Parser 202. The CIL Parser 202 generates Alarm Types 203, Unit Types 204 and Device Types 205, which are stored as Type Information 206.

The CIL Parser 202 further generates Static Units 207 in the Information Model 208 according to the invention. Further the CIL Parser 202 generates Database Parameters 209, the CIL Application 210 and a I/O Equipment Parser 211. The term Static Units refers to logical representations of Units which do not correspond to any I/O Devices. This as a contrast to Dynamic Units (212), which are logical representations of Units corresponding to I/O Devices.

The I/O Equipment Parser thus is an I/O Device pattern matcher. The different Device patterns are defined in the CIL-file. The I/O Equipment Parser scans for defined patterns in a list of I/O Devices provided by different I/O Interface handlers of the EEM2001 Platform.

For each recognized pattern the I/O Equipment Parser generates the corresponding Dynamic Units.

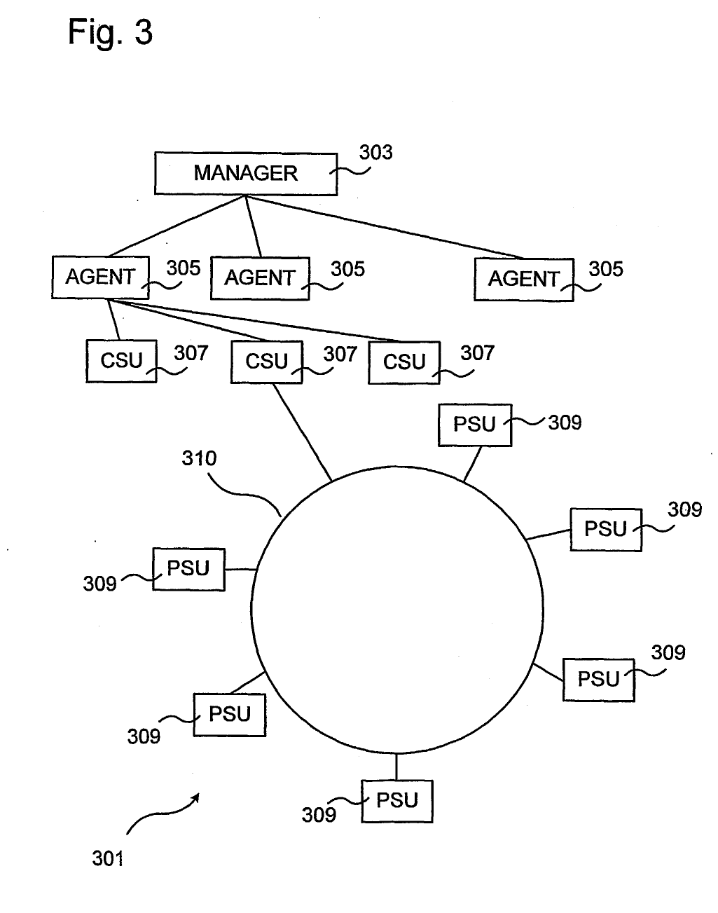

In FIG. 3, the general structure of equipment in a power supply system 301 is shown. The system 301, as shown is used for supplying telecommunication system units with power. This system may be a system according to prior art or it may represent a system to be used in accordance with the invention. This implies that the physical entities of the system may be equivalent but the difference lies in the type of management system used to manage the power supply system. The power supply system comprises a Manager 303 connected to a number of agents 305, each collecting data from one or more central supervision units (CSU) 307.

Each CSU 307 is connected to a number of power supply units 309, such as batteries, rectifiers etc. The power supply units are connected by e.g. an optical fiber 310 or the like to the CSU.

The CSU forwards information regarding the operation of the power supply units, such as output voltage etc. which the system has been programmed to forward. The information is forwarded from each CSU to the Agent, and from there to the Manager using TCP/IP connection. The Agent may of course, in some applications function as the Manager and the CSU perform as the Agent, depending on the complexity of the system.

Thus, each Agent collects information from all CSUs 107 to which it is connected and forwards the information to the Manager 103. The Manager thus has access to all information from the CSUs in the system, may evaluate the information, act on it, and be adapted to present the information in a pre-determined form.

According to the invention the management system uses the EMM-core according to FIG. 1 in order to supervise and control a system for providing management of power supply units

Further, according to the invention a means, i.e. a method and a device for defining configuration information has been accomplished through the EEM CIL. EEM CIL comprises information/statements relating to units, properties, alarms etc and is termed EEM Configuration “Language”. The configuration information defines all details that are related to the EEM Information Model (A hierarchical model of the information on an energy site), i.e. Equipment types and Property sets, Alarm types, Alarm Outputs and Alarm Severity Outputs etc.

This makes it possible to define the transformation (and mapping) of the topology of the physical I/O Devices to a logical Information Model of the supervised equipment. By using the CIL Components, which are executable modules, taking values from one or more inputs and performing some kind of algorithm (e.g.) a sum, average, or e.g. an alarm will be generated and presented on one or more outputs.

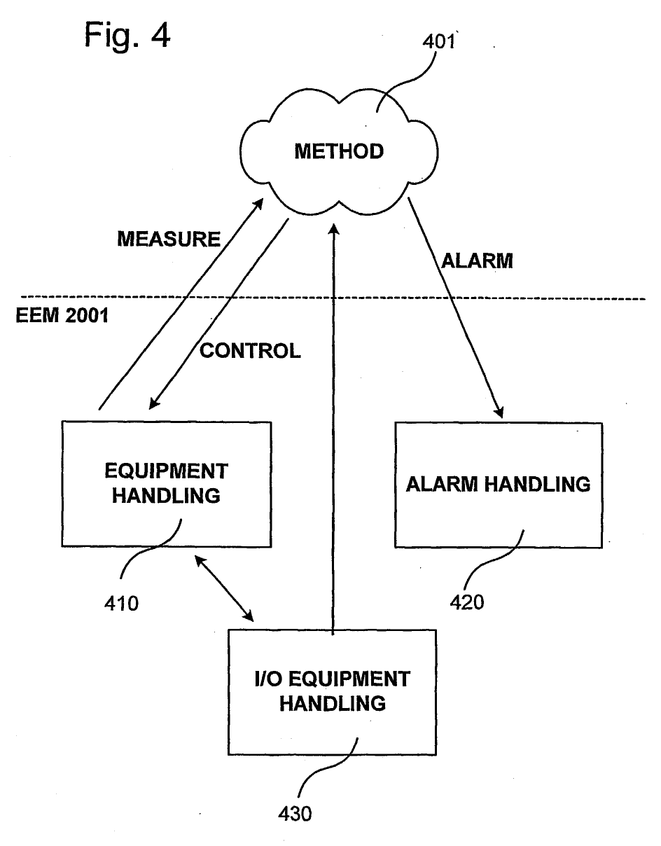

In FIG. 4 the relation between the method according to the invention and the EEM software platform is illustrated. In the figure is shown the relation and interaction between the Method 401 in the form of an application and the three units comprised in the EEM Platform, Equipment Handling 410, Alarm Handling 420, and I/O Equipment Handling 430. In the figure is shown that in the method according to the invention the I/O Equipment Handling 430 triggers the execution of the application. The application accesses the Information Model (comprised in the Equipment Handling 410) by reading values, calculating values, and setting values. The application will also check the values for alarming conditions and manipulate the Alarm Handling 420 system accordingly.

The invention also relates to a CIL Execution Model. The design of such a model is based upon an electric circuit metaphor. By connecting standard building blocks, components, one can create new building blocks and applications, in the sense of both the physical unit and the corresponding CIL Information and Execution Models.

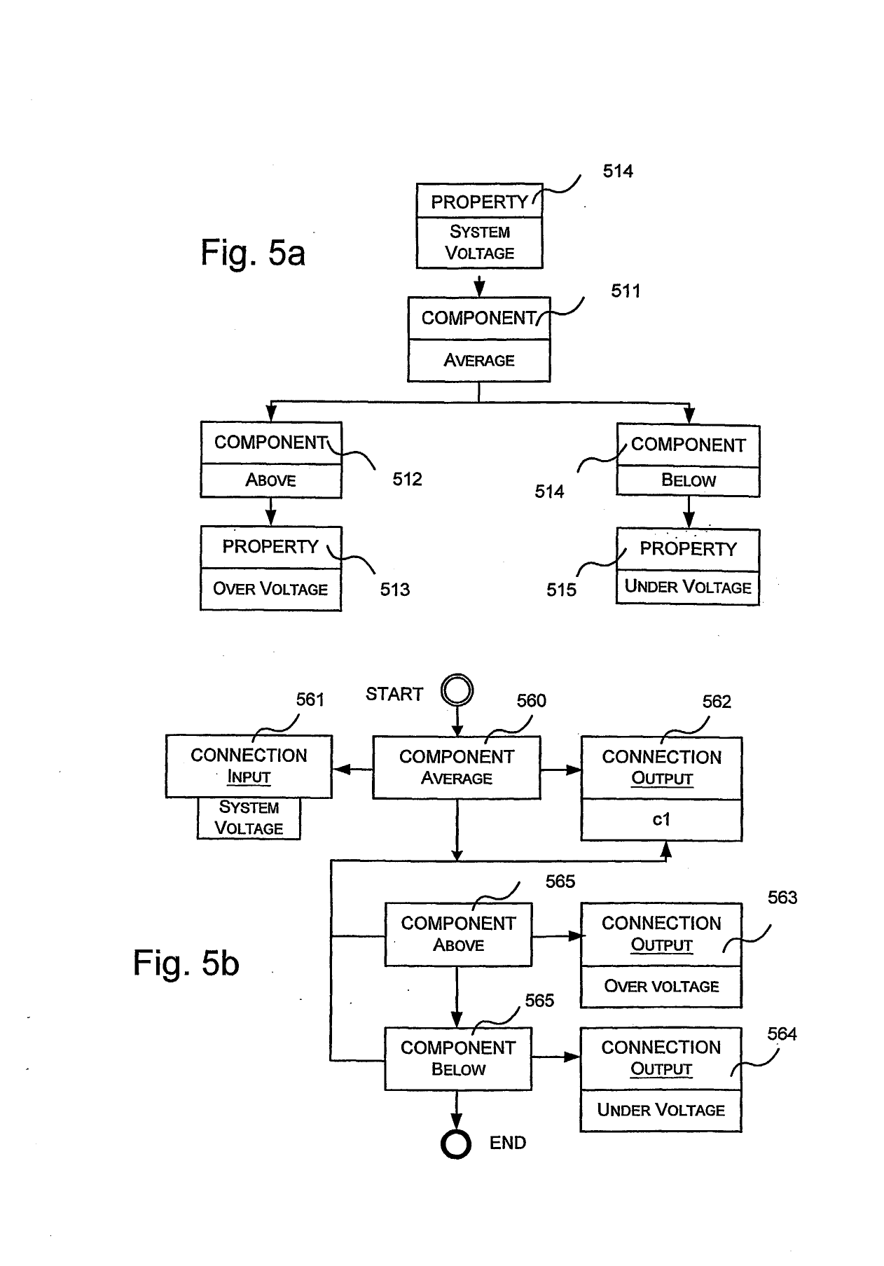

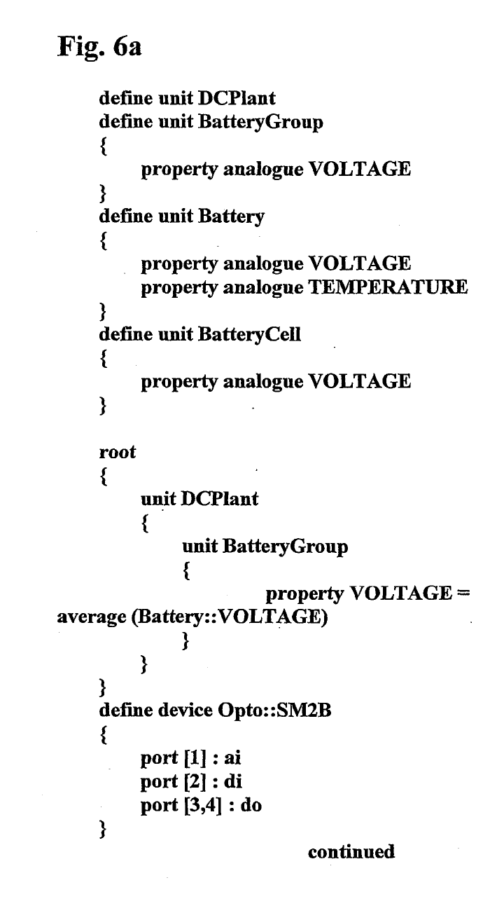

As an example a circuit diagram of a System Voltage Monitor and the corresponding executable Component in FIGS. 5a and 5b.

In FIG. 5a an Instance of a component average, i.e. a module for calculating values related to voltage in a component, is connected to the system Voltage Property circuit diagram for a System Voltage Monitor. The average Component calculates the average of e.g. the ten last measured values of the System Voltage 510. In order to detect over and under voltage the two component instances, above 512 and below 514, are connected to average component instance 511. The two components (above and below) are used as Alarm Detectors and connected to an Alarm Indicator that corresponds to their Alarming Condition.

The execution order corresponds to the data flow and looks e.g. like the one shown in FIG. 5b. FIG. 5b represents the CIL Component Model for a System Voltage Monitor. Each “executable” is an instance of a “Component” Each Component instance has a set of inputs and outputs. The Component correspond to what in programming is called a sub-routine. The component, when instanced is an executable module. In this example there is once input and one output for each Component instance. The input 560 is connected to the System Voltage property 561 ( of e.g. the equipment Unit DC Plant), and to the Component average 560. The Component Instances (562, 563, 664) that depend on the average (above, and below) have their inputs connected to the output of Component average 560. And the outputs are connected to the corresponding properties C1 denoting the signal output from the component, Over voltage, and Under voltage (indicating the status of the Alarming condition). Components are instanced and inter-connected by Connections.

This may also be described in terms of a subroutine. The routine is initiated and in step 560 system voltage is sampled, an number of samples are averaged, in step 565 is controlled if the average value is above a predetermined first value. If the value is above the predetermined value a signal is sent to the output 563, if value is not above the predetermined first value the value is further controlled in step 5656 if the value is below a second predetermined value. If the value is below the second predetermined value a signal is sent in step 564 to the output 564. If the value is not below the second predetermined value a signal will be sent in step 566 to the output 562 indicating a clear signal.

Context is defined as an “executable” and contains CIL Statements and a listener for update events. At each update event the Context executes the CIL Statements, i.e., the Context is a mechanism for associating the execution of a data flow with an update event.

The EEM 2001 Platform contains a predefined set of components, Standard Components”. Application specific components may be written in C++, and linked in the application binary image, or defined in a CIL file. The application specific components defined in CIL are called Macro Components.

A CIL file may also comprise Statements, Statements are executable objects that are chained into a sequence. The execution of such a sequence is invoked by a Context that is triggered when a data exchange has succeeded.

Using CIL, e.g. each combination of SM Devices (supervising devices for control of rectifiers) may be described in a hierarchic way. The combinations consists of a set of I/O Devices which in turn consists of a number of Equipment Units. Each Equipment Unit contains a set of properties where each property is mapped to a port on the I/O Device that the Equipment Unit is reflecting.

The Configuration Information is divided into the following sections:

Type Definitions defining Equipment types, Alarm types and I/O Device types

Information Model, the static and dynamic part of the Information Model. The dynamic part defines valid combinations of I/O Devices and how they are correlated to the Information Model (which Equipment Units that should be created for each detected I/O Device).

CIL Application, which is defined by Update groups, execution Contexts and functional Components containing Executable objects.

Database Parameters, persistent and volatile parameters.

An example of the attachment of a Property to a port of the associated I/O Device may look as below:

combination Opto::53
{

device SM3::53:1

{

unit Rectifier Group::Rectifier
{

.....
property VOLTAGE = port [7]
.....

}

}

}

In the example above Opto refers to an opto loop to which the devices are physically attached. A device SM3, already defined in CIL, attached to the opto loop has a unit rectifier group and the Propety VOLTAGE (of Rectifier) is connected to I/O Port #7 (in the SM3).

Thus the hierarchical build-up of the model is shown. “53” refers to a Combination.

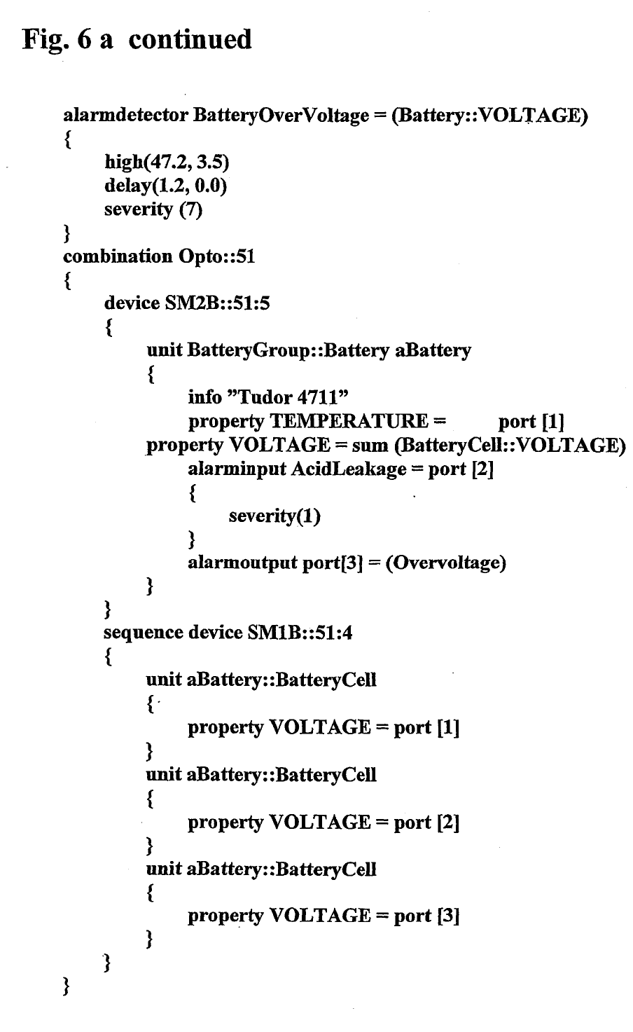

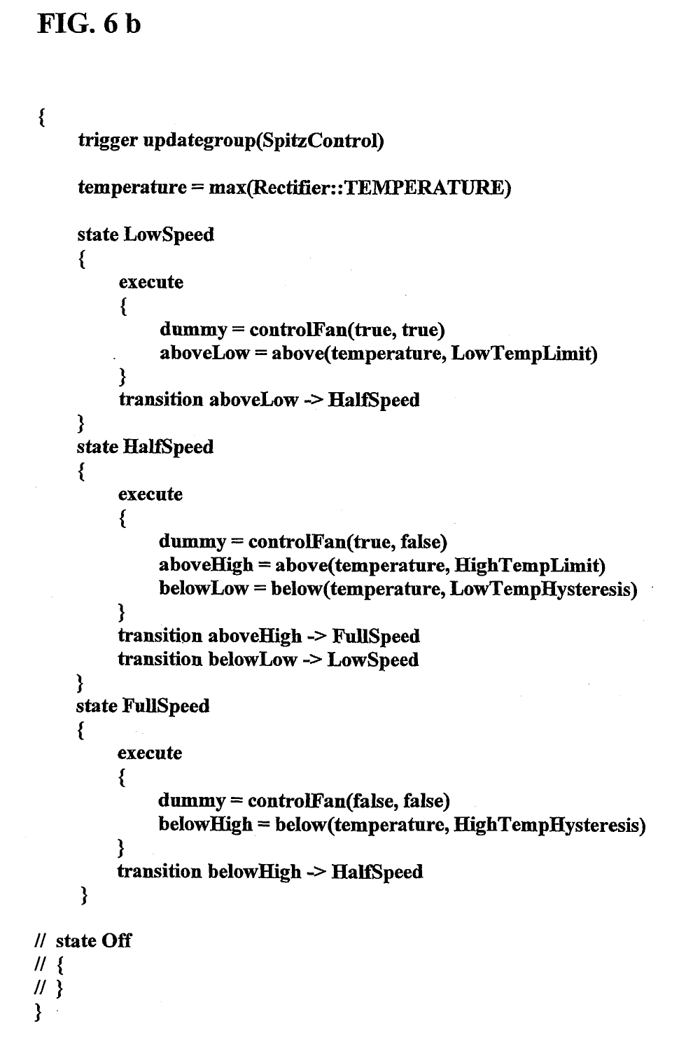

In FIG. 6a illustrates a software description of a combination of input/output (I/O) Devices, i.e. a configuration file. The mapping of the ports are shown in the sequence on the second page starting line 7 with “combination Opto::51”.

In FIG. 6b is shown an example of a CIL-notation, a “Component” describing a “sub-routine” which controls a fan used for cooling of a rectifier. The object is to use the temperature of the rectifier and compare this temperature with predetermined values. The comparison will result in regulation of the speed of the fan.

In this figure “state” and “transition” stand for the two States making up a State Machine. As the entry action into the state has been triggered by an update group “(SpitzControl) the initial/default state is normal. If the temperature is under a set maximum temperature the fan will run with low speed. An Execute follows in which the temperature is checked. A more complete description is the following:

In this figure we have a Context named FanControl that contains a State Machine that consists of three states: “LowSpeed”, “HalfSpeed” and “FullSpeed”. The execution of the Context is triggered by an update group (“SpitzControl”). The initial/start state is the first defined state (“LowSpeed”). The objective of FanControl is to regulate the speed a fan in order to cool a number of rectifiers. The fan can run at three speeds (hence the three states). The highest (max) rectifier temperature is used in the regulation. When in LowSpeed, if the temperature exceeds a certain limit there will be a transition to the state HalfSpeed. In the state HalfSpeed there are two transitions to either “LowSpeed” or “FullSpeed” depending on a temperature increase or decrease.

It should be pointed out that the above example, and also in the examples, shown in FIG. 6a and FIG. 6b other notations may be used for equivalent devices etc. The exact notation for an object, a property etc., may of course be changed without changing the concept of the invention.

For each I/O Device there will, in the most cases , be defined at least one Equipment Unit. The properties of the created Equipment Unit are mapped to the ports of the I/O Device, this is handled in a unit clause.

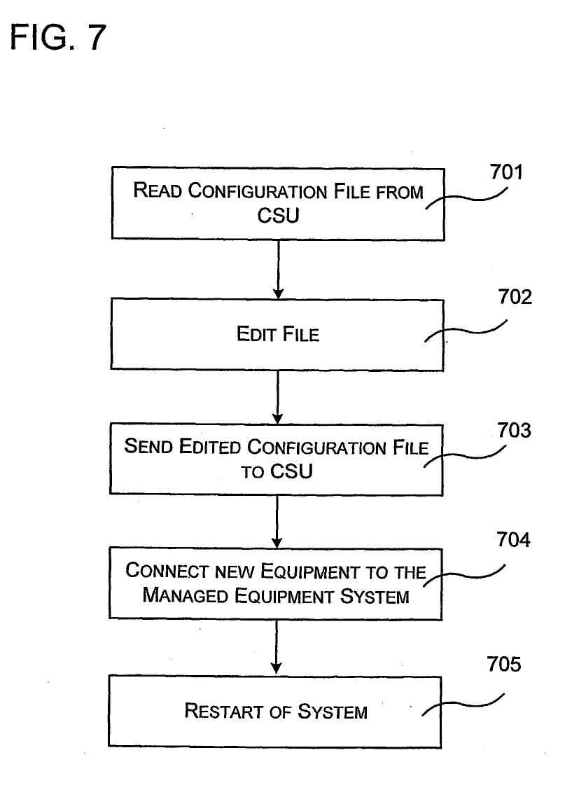

In FIG. 7 the steps carried out when adding a piece of new piece of equipment in the Equipment System as shown in FIG. 3. In a first step 701 the Configuration File of the existing Equipment System is read from the CSU (Central Processing Unit) to which e.g. an number of Power Supply Units are connected, and to which new equipment is to be added. The text is edited in step 702 using the same manner of adding information as in the example above. In this step is comprised adding the definition of the new equipment to be added, a possible new definition of a new type of equipment, and additional information regarding alarms, updates etc. which will be used by the CIL Application. This addition of information may be done using a text editor or a special application program. In step 703 the edited Configuration File is sent back to the CSU.

In step 704 the physical connection between the added equipment and the Equipment System is accomplished.

In step 705 the CIL Application is restarted in the CSU.

Using the Software-system herein described it is thus possible to hierarchically describe how each combination of I/O Device are built up and also to describe the behavior of each combination and also in the Equipment system comprising several combinations.

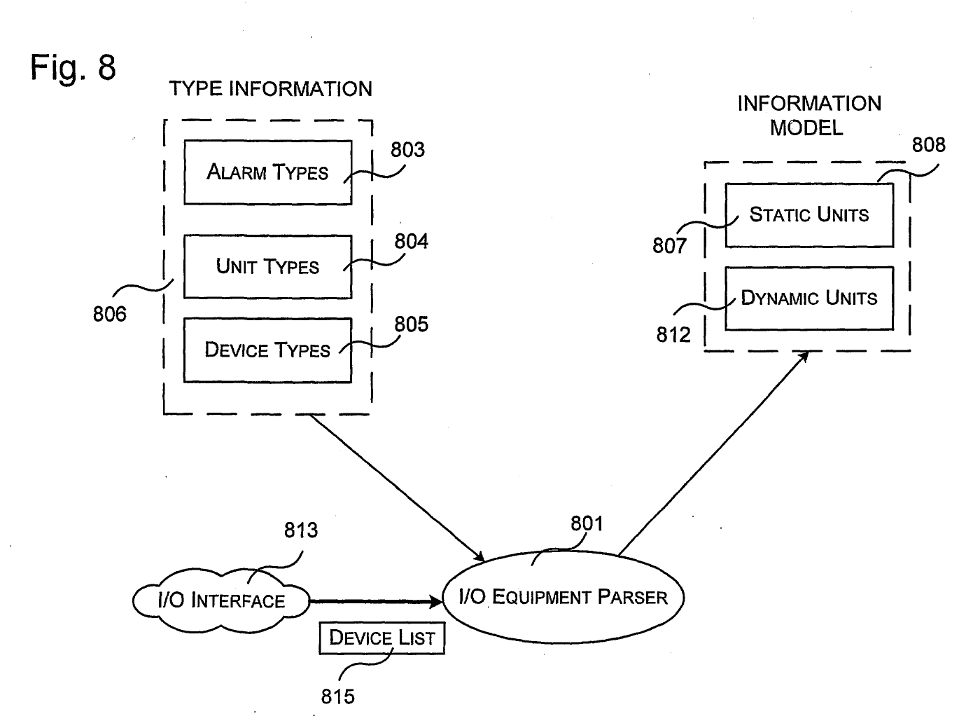

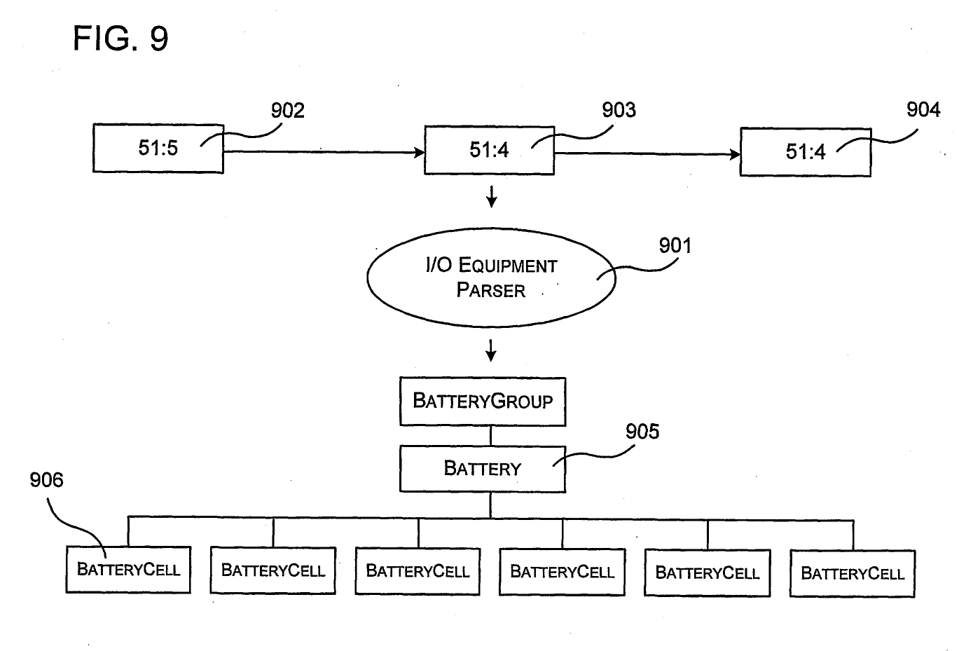

An example of how the software as described above in FIG. 6a may be used in a power supply system is discussed referring to FIG. 8 and FIG. 9. In the example, the I/O Interface 813 of the Optical Fiber Loop detects three I/O devices and forwards an I/O Device List 815 to the I/O equipment handler (not shown), which in turn requests the I/O equipment parser 801 to parse the list.

When the CIL file is parsed by the CIL Parser the following steps will be performed by the system on which the computer program is executed.

The Equipment Types, DCPlant, BatteryGroup, Battery and BatteryCell are created and inserted into Information Model in the Equipment Handler

The Static Unit structure is created containing one DCPlant, which in turn contains one BatteryGroup unit where the VOLTAGE property value is calculated from the average of the VOLTAGE property of all the Battery units that are in the Battery Group Unit.

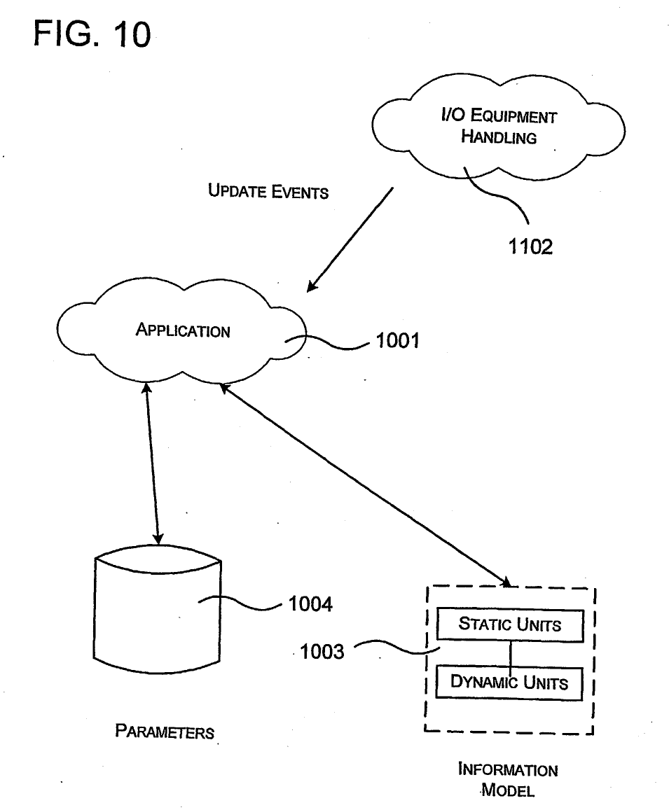

The CIL Parser will take I/O Device definitions and generate a data base (corresponds to 214 in FIG. 2 and 1004 in FIG. 10) which is used by the I/O Equipment Parser to look up the port layout for a specific I/O Device.

An Alarm detector is defined for supervision of the VOLTAGE property of all the Battery units.

Thus the Configuration Information Parser uses the information to generate a parse tree, shown in FIG. 9, that is used by the I/O Equipment Parser 901 (801 in FIG. 8).

When the I/O Interface 802 initiates the Optical loop it will detect three I/O Devices 902, 903, and 904. The group (and subgroup) numbers (51:5, 51:4, and 51:4) are inserted in an I/O device list 815 shown in FIG. 8, and sent to the I/O Equipment Parser 801 which will iterate over the list and match each element with the parse tree.

First the I/O Equipment Parser 801 finds an I/O device of type SM2B (902) and that a Battery unit (905) should be created and associated with that I/O Device. The I/O Equipment Parser 801 will store a name reference to the created Battery unit “aBattery”.

The created properties for the Battery unit states that the product info is. e.g. “Tudor 4711”, the TEMPERATURE property is mapped to port #1, the property VOLTAGE is the sum of the VOLTAGE property of all BatteryCell units. Furthermore, there is one alarm input attached to port #2 and one alarm output attached to port #3.

Thereafter the I/O Equipment-Parser 901 will find two I/O Devices 51:4 903, 904, and from information stored “conclude” that they are I/O Devices of type SM1B and create three Battery Cell units 906 for each I/O Device. The Battery Cell units inserted into the Battery unit 905, which will be referred to using the reference “aBattery”. The result of these operations is the structure depicted in FIG. 9.

In FIG. 10 is shown The CIL Application 1001 according to the invention and its interactions according to the invention:

Update Events from the I/O Equipment Handling 1002, whenever a change has been made in the physical combination of the application, i.e. the units comprised in the controlled/managed combination of objects under the CSU, i.e. the addition of more batteries, rectifiers etc.

the interchange with the Information Model 1003, comprising the Static Units and the Dynamic Units. The information Model 1003 created and recreated whenever a change has been made to the configuration of the controlled/managed combination of objects.

the access of the Parameter Database 1004.

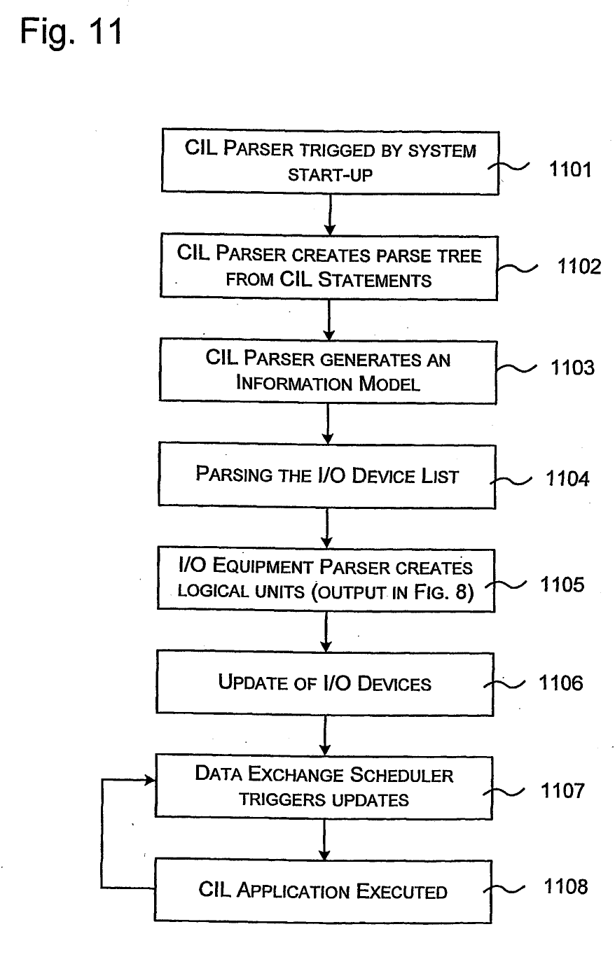

In FIG. 11 is shown schematically the chronology of the events taking place in connection with the CIL Application.

In Step 1101 the CIL Parser is triggered by a system start-up or a reboot.

In Step 1102 the CIL Parser creates a parse tree from CIL Statements taking configuration information as an input. The output of the CIL Parser is shown and described in connection with FIG. 2.

In step 1103 the CIL Parser generates an Information Model from the Configuration Information correlating to the I/O Device sequence present.

In Step 1104 parsing is done of the I/O Devices atached.

In Step 1105 the I/O Equipment Parser creates logical units. The output is shown in FIG. 8.

In Step 1106 the I/O Devices are updated according to a schedule defined by each Update Group. When an Update Group has completed its update sequence an Update Event will be issued.

In Step 1107 the data Exchange Scheduler triggers Updates according to Update Groups.

In Step 1108 the Cil Application is executed. The Application will then be updated according to triggers in Step 1107.

The CIL Application Statements can thus be used to instruct and control a particular CSU how to interpret the information from different I/O devices and from this information build a data structure, called a CIL Application, and to load that directly into the CSU. The CIL Parser in each CSU can then dynamically create a I/O Equipment Parser, which parser is able to parse through the detected I/O devices and can create a logical model from the information obtained during the parsing thereof.

One of the important features of CIL is possibility of I/O device pattern matching. The possibility to match an I/O device pattern, i.e. the CIL file combination, makes it possible to describe how a certain combination of I/O devices should be mapped to one or more energy equipment units. The mapping illustrated in connection with FIG. 7.

Finally the use of CIL makes it possible to when new equipment is added to a configuration to only add new parameters in the configuration file and distribute the new configuration. This makes the system user-friendly and easy to handle and change and makes re-writing of all the entire software and distribution of the same unnecessary.

1. A method for management of power supply units comprising at least one central supervising unit (CSU) (307), and at least one combination (301) of power supply units (PSU) (309), said units connected to said central supervising unit (CSU) (307), said at least one combination (301) to be managed by said at least one central supervising unit, the method comprising following steps:
(a) parsing information contained in a CIL File (201), said file describing, through the use of CIL statements, physical units connected to the combination using a first parser (202);
(b) said first parser creating from said information an Information Model (208) comprising Static Units (207) and Dynamic Units (212), a Type Information (206) comprising Alarm Types (203), Unit Types (204), and Device Types (205);
(c) said first parser further creating a second parser, I/O Equipment Parser (211) for parsing aDevice List (815) provided by an I/O Interface (813), said Interface being the connection to the at least one combination (301) to be managed by said at least one central supervising Unit (CSU);
(d) said first parser also creating from further CIL Statements contained in the CIL File (201), an Application (210) for management of the units contained in the Combination (301).
(e) said application using the Information Model (208) and the Type Information (206) in managing the Combination (301)

2. A method according to claim 1, in which Update Groups are created in an Application (210), said Update Groups used by a Data exchange Scheduler (1107) for triggering updates of the I/O Device List (803) followed by updates of the type Information (206), the Information Model (208) and the Application (210).

3. A method according to claim 1 or 2, in which the CIL File, upon a change of the Equipment comprised in the Combination (301) is edited using CIL Statements upon which the method according to Step (a) until Step (e) is performed.

4. A method according to claim 1 or 2, in which upon a change of the Equipment comprised in the Combination (301) the method according to Step (a) until Step (e) is performed.

5. A power supply system comprising power supply units, said system comprising at least one central supervising unit (CSU) (307), and at least one combination (301) of power supply units (PSU) (309), said units connected to said central supervising unit (CSU) (307), said at least one combination (301) to be managed by said at least one central supervising unit characterized by means (202) for
(a) parsing information contained in a CIL File (201), said file describing, through the use of CIL statements, physical units connected to the combination;
(b) creating from said information an Information Model (208) comprising Static Units (207) and Dynamic Units (212), a Type Information (206) comprising Alarm Types (203), Unit Types (204), and Device Types (205);
(c) for creating a second parser, I/O Equipment Parser (211) for parsing a Device List (815) provided by an 1/O Interface (813), said Interface being the connection to the at least one combination (301) to be managed by said at least one central supervising Unit (CSU);
(d) for creating from further CIL Statements contained in the CIL File (201), an Application (210) for management of the units contained in the Combination (301).
(e) for using the Information Model (208) and the Type Information (206) in order to manage the Combination (301)

6. A power supply system according to claim 5, said system having means (210) for creating Update groups, said update groups to used by a Data exchange Scheduler (1107) for triggering updates of I/O Device List (803) followed by updates of the type Information (206), the Information Model (208) and the Application (210).

7. A power supply system according to claim 5 or 6, said system having means for editing the CIL File, upon a change of the Equipment comprised in the Combination (301) using CIL Statements.

8. A computer program, which when run on a computer, in a method for management of power supply units comprising at least one central supervising unit (CSU) (307), and at least one combination (301) of power supply units (PSU) (309), said units connected to said central supervising unit (CSU) (307), said at least one combination (301) to be managed by said at least one central supervising unit, performs the following steps:
(a) parsing information contained in a CIL File (201), said file describing, through the use of CIL statements, physical units connected to the combination using a first parser (202);
(b) said first parser creating from said information an Information Model (208) comprising Static Units (207) and Dynamic Units (212), a Type Information (206) comprising Alarm Types (203), Unit Types (204), and Device Types (205);
(c) said first parser further creating a second parser, I/O Equipment Parser (211) for parsing a Device List (815) provided by an I/O Interface (813), said Interface being the connection to the at least one combination (301) to be managed by said at least one central supervising Unit (CSU);
(d) said first parser also creating from further CIL Statements contained in the CIL File (201), an Application (210) for management of the units contained in the Combination (301).
(e) said Application (210) using the Information Model (208) and the Type Information (206) in managing the Combination (301).

9. A computer program, which when run on a computer performs the method according to claim 8, in which Update Groups are created in an Application (210), said Update Groups used by a Data exchange Scheduler (1107) for triggering updates of the I/O Device List (803) followed by updates of the Type Information (206), the Information Model (208) and the Application (210).

10. A computer program, which when run on a computer performs the method according to any of the claims 8 or 9, in which the CIL File, upon a change of the Equipment comprised in the Combination (301) is edited using CIL Statements upon which the method according to Step (a) until Step (e) is performed.

11. A computer program, which when run on a computer performs the method according to any of the claims 8 or 9, in which upon a change of the Equipment comprised in the Combination (301) the method according to Step (a) until Step (e) is performed.
